(19) United States
(12) Patent Application Publication
(10) Pub. No.: US 2016/0267583 A1
(43) Pub. Date: Sep. 15, 2016

(54) ELECTRONIC DATA MODELLING TOOL

(71) Applicant: International Business Machines Corporation, Armonk, NY (US)

(72) Inventors: Hongliang Fei, Millwood, NY (US); Miao He, Beijing (CN); Hongfei Li, Briarcliff Manor, NY (US); Buyue Qian, Ossining, NY (US)

(21) Appl. No.: 14/641,706

(22) Filed: Mar. 9, 2015

(51) Int. Cl. G06Q 40/02

(52) U.S. Cl. CPC G06Q 40/025

(57) ABSTRACT

Generating an electronic data model of a logical supply chain and regenerating the model based on changes to modelling parameters, to guide decision making. The data model is generated using known information about the supply chain. One or more decision scenarios are modelled based on a simulated loan request, and the data model is regenerated to consider the consequences. A recommendation is made based on pre-defined or user-defined criteria.

### BACKGROUND

The present invention relates generally to the field of data modelling, and more particularly to graphical data modelling techniques and tools.

In commerce, it is a growing practice for companies to engage in intra supply-chain financing in order to optimize availability and cost of capital within the supply chain. In some circumstances, suppliers obtain short-term financing secured against their own accounts receivable, which create a number of problems resulting from having to take on short-term debt; for example, a lower credit rating. This burden on suppliers also impacts buyers; buyers often rely on suppliers to sustain their own businesses.

Supply chain financing allows a buyer and a seller to collaborate in this process, such that suppliers can leverage a buyer's accounts payable to receive immediate payment of their receivables, thereby avoiding the need for incurring short-term financing debt. The buyers, in turn, have more flexibility in making payments to their suppliers.

### SUMMARY

The demand for supply chain financing tools has increased greatly, and represents a large but mostly unsatisfied need. In contrast to the prior art, embodiments of the disclosed invention provide a method, system, and computer program product that enable decision makers to better visualize and understand the landscape of the supply chain, their options in making decisions, and the impact of those decisions, and to make informed decisions based on that understanding.

Embodiments of the present invention disclose a method, computer program product, and system for generating an electronic data model.

According to an embodiment, a method for generating an electronic data model obtains an electronic data model of a logical supply chain. The electronic data model includes a lender node and a borrower node. The method regenerates the electronic data model based on at least one decision scenario in response to a request by the borrower node to the lender node to finance a loan. The request is based on one or more of a request received from the borrower node and a simulated request from the borrower node. The method determines corresponding gain values and probabilities of occurrence, for the lender node, of the at least one decision scenario. The corresponding gain values and probabilities of occurrence are determined with respect to the lender node and at least one node in the electronic data model other than the borrower node. The method recommends a decision according to the at least one decision scenario, in response to the request, based on the gain values and probabilities of occurrence.

According to a further embodiment, a computer system for generating an electronic data model includes a computer device having a processor and a tangible storage device, and a program embodied on the storage device for execution by the processor. The program has a plurality of program instructions that, when executed by the processor, cause the processor to obtain an electronic data model of a logical supply chain, where the electronic data model includes a lender node and a borrower node. The instructions cause the processor to regenerate the electronic data model based on at least one decision scenario in response to a request by the borrower node to the lender node to finance a loan. The request is based on one or more of a request received from the borrower node and a simulated request from the borrower node. The instructions cause the processor to determine corresponding gain values and probabilities of occurrence, for the lender node, of the at least one decision scenario, where the corresponding gain values and probabilities of occurrence are determined with respect to the lender node and at least one node in the electronic data model other than the borrower node. The instructions cause the processor to recommend a decision according to the at least one decision scenario, in response to the request, based on the gain values and probabilities of occurrence.

According to a further embodiment, a computer program product for generating an electronic data model includes a tangible storage device embodying program code. The program code is executable by a processor of a computer to perform a method. The method obtains, by the processor, an electronic data model of a logical supply chain. The electronic data model includes a lender node and a borrower node. The method regenerates, by the processor, the electronic data model based on at least one decision scenario in response to a request by the borrower node to the lender node to finance a loan. The request is based on one or more of a request received from the borrower node and a simulated request from the borrower node. The method determines, by the processor, corresponding gain values and probabilities of occurrence, for the lender node, of the at least one decision scenario. The corresponding gain values and probabilities of occurrence are determined, by the processor, with respect to the lender node and at least one node in the electronic data model other than the borrower node. The method recommends, by the processor, a decision according to the at least one decision scenario, in response to the request, based on the gain values and probabilities of occurrence.

### BRIEF DESCRIPTION OF THE SEVERAL VIEWS OF THE DRAWINGS

FIG. 1 is a block diagram illustrating a model of a logical supply chain, according to an embodiment of the invention.

FIG. 2 is a block diagram of a supply chain analytics system, according to an embodiment of the invention.

FIG. 3 is a block diagram of an electronic data model of a supply chain, according to an embodiment of the invention.

FIG. 4 is a flowchart of a method for providing electronic data models to simulate decision scenarios, based on the electronic data model of FIG. 3, according to an embodiment of the invention.

FIG. 5 is a block diagram of details of some of the components of the analytics system of FIG. 2, including types of information used in the method of FIG. 4, according to an embodiment of the invention.

FIGS. 6A-D are block diagrams depicting electronic data models regenerated based on the electronic data model of FIG. 3 and based on operations of the method of FIG. 4, according to an embodiment of the invention.

FIG. 7 is a block diagram depicting components of a computer system, according to an embodiment of the invention.

### DETAILED DESCRIPTION

Embodiments of the present invention provide a modelling tool for evaluating the financial risk to be borne by a lender, such as a supplier in a supply chain, by taking into account the physical supply chain (i.e., actual flow of materials) during supply chain financing decisions. The framework provides for both a quantitative and dynamic validation model for supply chain financing decision making that takes into account the larger supply chain structure in order to determine long term impacts. Existing supply chain financing solutions do not take into account the supply chain structure but instead rely on business rules with expert knowledge input, and only provide limited knowledge about the direct single supply thread, instead of the entire supply chain network. No existing supply chain financing modelling solution evaluates the whole network and provides information on long term impacts. In other words, current solutions do not offer any insight as to the fact that suppliers often have multiple buyers that can act as competing supply chain financiers, and buyers may have multiple suppliers that may act as competing suppliers of the borrower, and those suppliers may in turn have supply chain connections between themselves.

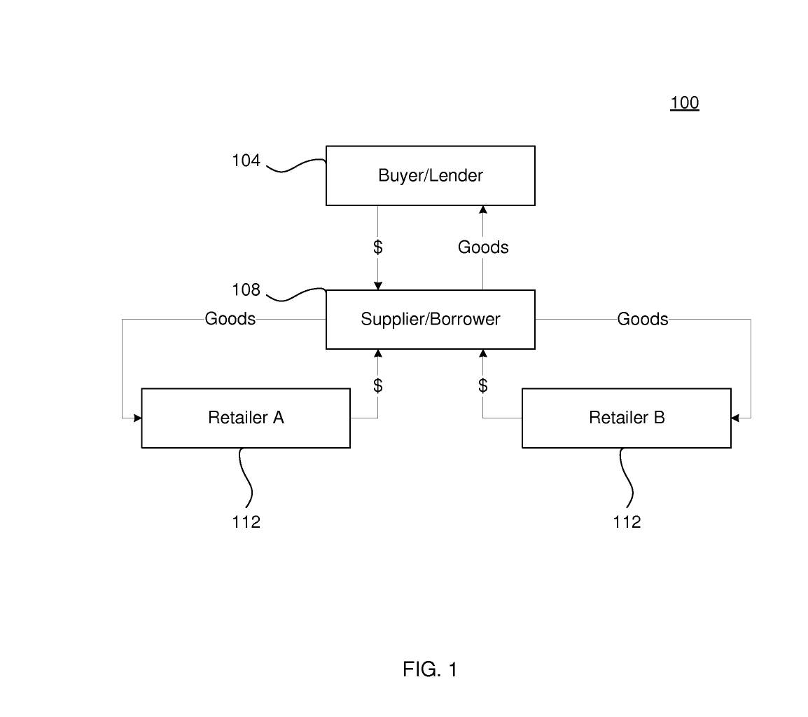

FIG. 1 is a block diagram illustrating a model of logical a supply chain 100 (hereinafter, “supply chain 100”), according to an embodiment of the invention. Supply chain 100 includes a set of members having a set of predefined relationships. The predefined relationships may be based on financial and business associations. For example, a member may act as a lender with respect to another member, in which case their corresponding relationship is indicated by an arrow connection and a “$” symbol, where the direction of the arrow indicates the direction of capital flow from the lender to the borrower. As a further example, a member may act as a supplier of goods to another member, in which case their corresponding relationship is indicated by an arrow connection and a “goods” label, where the direction of the arrow indicates the direction of goods flow. The members of supply chain 100 include, in this example, a buyer/lender 104 (hereinafter, “lender 104”), a supplier/borrower 108 (hereinafter, “borrower 108”), and two retailers 112, including Retailer A and Retailer B. Connections between members of supply chain 100 represent relationships between these members. For example, lender 104 receives goods from borrower 108, and in return provides money to borrower 108. Borrower 108 receives money from Retailer A and Retailer B (each of whom is a retailer 112), and provides goods in return.

Supply chain 100 is an illustrative example of a model of a supply chain. Embodiments of the invention may use information about such supply chains to analyze the model data, provide tools for making informed decisions, and recommend financing decisions based on that model.

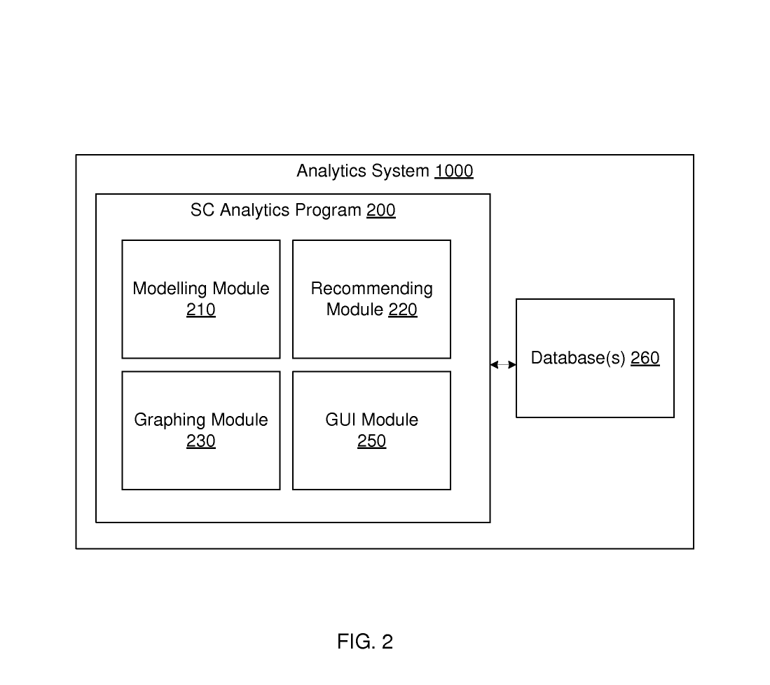

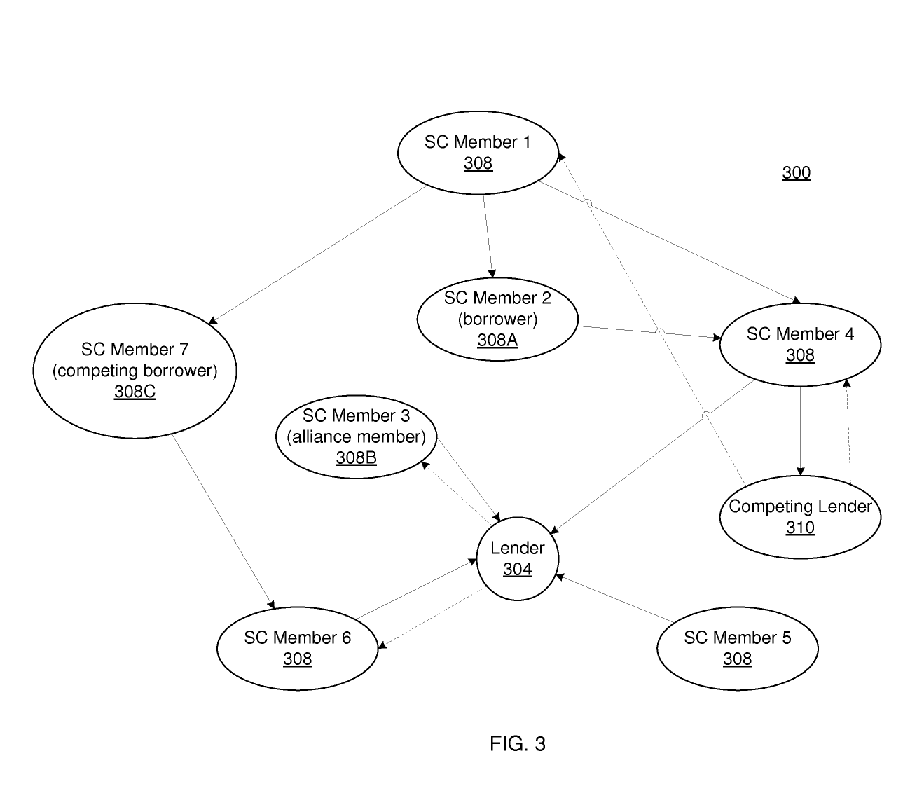

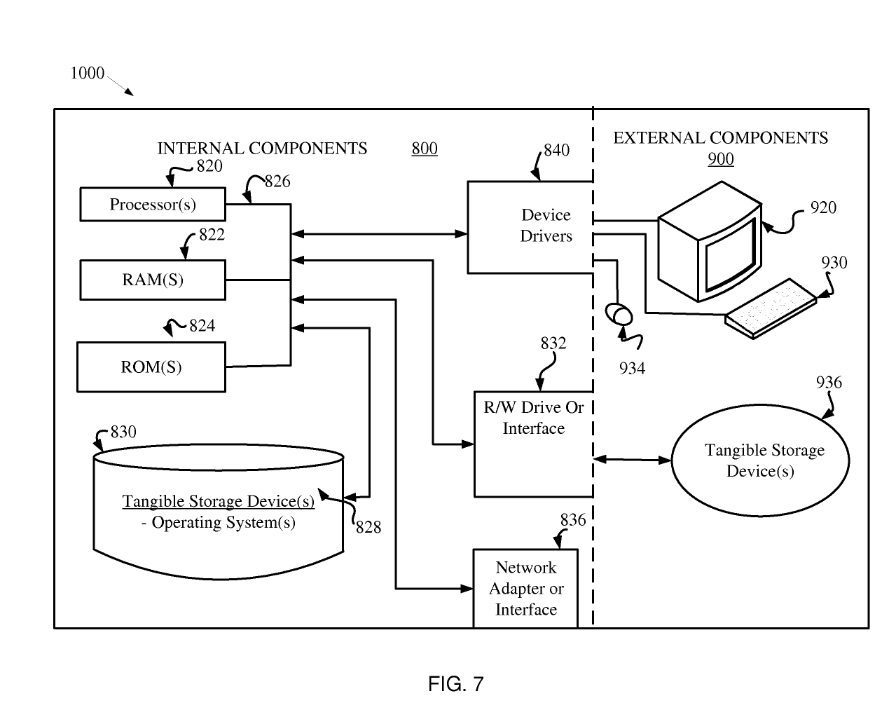

FIG. 2 is a block diagram of a supply chain analytics system 1000 (hereinafter, “analytics system 1000”), according to an embodiment of the invention Analytics system 1000 may generally function to perform modelling, analysis, and recommendation functions in connection with a logical supply chain, such as supply chain 100 of FIG. 1, or another supply chain (for example, the supply chain of FIG. 3). Analytics system 1000 may include one or more computing devices as described in detail in connection with FIG. 7, below. Analytics system 1000 may further include a supply chain analytics program 200 (hereinafter, “SC analytics program 200”) and a database(s) 260.

SC analytics program 200 may be a computer program stored on a tangible storage medium of analytics system 1000, and may include program modules or program instructions to perform one or more methods according to embodiments of the invention. These instructions may be executable by a processor (not shown) of analytics system 1000.

According to an aspect of the invention, SC analytics program 200 may have the following program modules: (i) a modelling module 210 configured to receive data identifying a logical supply chain, the supply chain's members, and relationships between the members, and to generate corresponding data models; (ii) a recommending module 220 configured to analyze the data models of the supply chain generated by modelling module 210, and to guide decision making by providing analysis of various scenarios, and recommendations; (iii) a graphing module 230 configured to generate graphical data models based on the data models generated by modelling module 210; and (iv) a graphical user interface (“GUI”) 250 configured to communicate with a user (not shown) to display outputs of modelling module 210, recommending module 220, and graphing module 230 and other pertinent information to the user, and to receive input from the user to guide additional functions of modules of SC analytics program 200.

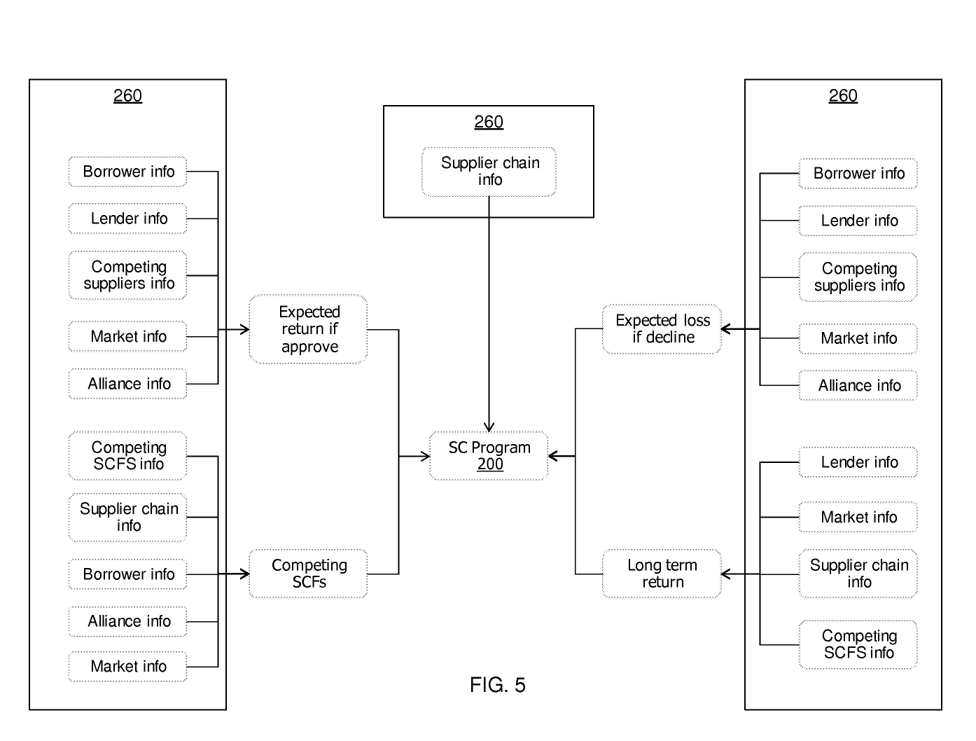

Database(s) 260 may include one or more tangible storage media that may store input and output data received/generated by analytics system 1000, and used by SC analytics program 200. Data stored on database 260 may include, for example and without limitation: supply chain structure data, supply chain member data, supply chain member relationships data, electronic logical model data, analysis data, recommendation data, and user data. Additional details of the type of data that may be stored on database 260 are depicted in FIG. 5, discussed below.

FIG. 3 is a block diagram of an electronic logical data model 300 (hereinafter, “model 300”) of a supply chain, according to an embodiment of the invention. Model 300 may be generated by modelling module 210 of SC analytics program 200 (FIG. 2) based on a supply chain's logical structure (for example, a supply chain similar to the one used to generate supply chain 100 in FIG. 1).

Model 300 includes a set of nodes corresponding to members of the supply chain on which model 300 is based. The nodes are identified by numeral references, as well as by functional role types. According to an embodiment of the invention, these nodes include a lender, identified by node 304; supply chain members 1-7 (referred to in FIG. 3 as “SC Member” 1-7), identified by nodes 308, 308A, 308B, and 308C; and a competing lender, identified by node 310. Each node in model 300 may, but need not, be connected to one or more additional nodes based on relationships of corresponding members of the underlying logical supply chain. For illustrative purposes, connections between nodes in model 300 are illustrated using solid lines and dashed lines, where solid lines indicate a physical product flow relationship, and dashed lines indicate a flow of capital (such as a loan) relationship, between a given pair of supply chain members.

Labels assigned to each node are for illustrative purposes only, and signify some of the relationships that members of the supply chain may have relative to one another. For example, the lender (node 304) in model 300 may correspond to a member in the supply chain that is both a supplier and a buyer, relative to one or more other members of the supply chain.

Entities of model 300 will now be described in greater detail according to their roles and relationships in model 300, according to an embodiment of the invention.

The lender (node 304) may be a node in model 300, relative to which additional nodes may be defined. The lender (node 304) may be, in an embodiment, a user of analytics system 1000 engaged in a financial decision making process. For example, the user may be a supplier in the supply chain (for example, in supply chain 100 of FIG. 1) on which model 300 is based. The user may have received (or may simulate receiving) a loan request from another member of the supply chain, or prospective member of the supply chain. The user may engage functions of analytics system 1000 to generate model 300, analyze the impact of possible decisions by the lender (node 304) in response to the request, and perform additional functions.

Other supply chain members, referred to as SC Members 1-7 (nodes 308, 308A, 308B, and 308C), may be members of the supply chain on which model 300 is based. These SC Members 1-7 may have direct or indirect relationships to the lender (node 304), and to each other.

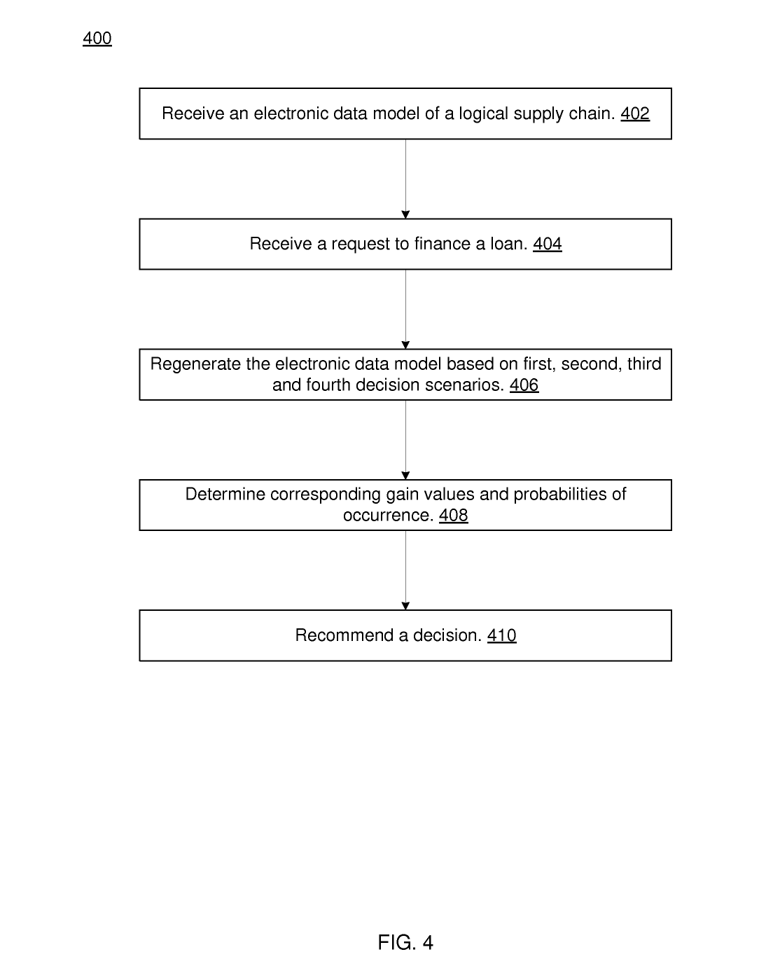

For example, SC Member 2 (node 308A) may be defined as a “borrower” relative to the lender (node 304) based on an existing or contemplated borrowing relationship. This relationship may be defined in the underlying data used to generate model 300. The indication that SC Member 2 is a borrower of the lender (node 304) may be used, in an embodiment of the invention, to perform special analysis with respect to ally entities that may otherwise not be available for other entities of model 300. These additional functions are described in greater detail in connection with method 400 and FIG. 4, below.

As a further example, SC Member 3 (node 308B), may be defined as an “alliance member” of lender (node 304) due to a defined relationship between the two. This relationship may be defined in the underlying data used to generate model 300. The relationship may correspond, for example, to a special business relationship that makes SC Member 3 an ally of lender (node 304). The indication that SC Member 3 is an ally of the lender (node 304) may be used, in an embodiment of the invention, to perform special analysis with respect to ally entities that may otherwise not be available for other entities of model 300. These additional functions are described in greater detail in connection with method 400 and FIG. 4, below.

As yet another example, SC Member 7 (node 308C) may be a competing borrower relative to SC Member 2 (node 308A), which is also a borrower. The distinction between these nodes in model 300 enables embodiments of the invention to distinguish between alternative borrowers and assess the impact of deciding to lend to one versus the other, by the lender (node 304).

The competing lender (node 310) may be a supply chain member defined as an alternative or competing source of capital available to SC Members 1-7, compared to the lender (node 304). Properties of the competing lender, such as its available capital, known decision making practices, and other characteristics, may be used by analytics system 1000 to perform its various functions, as described below in connection with method 400 and FIG. 4, below.

FIG. 4 is a flowchart depicting steps of a method 400 for providing an electronic data model, according to an embodiment of the invention. Method 400 may be executed by the processor of analytics system 1000 of FIG. 2 via one or more program modules of SC analytics program 200. Steps of method 400 are discussed in greater detail, below.

Additional embodiments of the invention will now be described in connection with FIGS. 2-5, and 6A-D. At step 402 of method 400, modelling module 210 of SC analytics program 200 receives an electronic data model of a logical supply chain. The logical supply chain may be similar to, for example, the logical supply chain 100 of FIG. 1. The electronic data model may be, for example, model 300 of FIG. 3.

In an alternative embodiment, modelling module 210 may generate model 300 itself based on data associated with a logical supply chain. Generating model 300 may include identifying members of the logical supply chain, designating them as nodes of model 300, characterizing the nodes based on predetermined (or based on determining) roles of the members in the logical supply chain, and connecting the nodes (logically or graphically) based on their relationships to one another, as described in connection with FIG. 3, above. For example, modelling module 210 may generate an electronic record corresponding to the lender (node 304). The electronic record may, in an example, include the following information as data and/or metadata: {node_type=member; lender=yes; lending_connections=SC Member 3, 6; supplier_connections=SC members 3, 4, 5, 6; competing_lender=node 310}.

Whether model 300 is generated or received by modelling module 210, it may have the same or a similar structure as that described above, or it may have a different structure.

At step 404, recommending module 220 may receive a simulated request to finance a loan. The request may be received from a user, which may be a method, system, process, machine, or a combination thereof. The request may also represent a request from a natural-person-user interacting with analytics system 1000 and SC analytics program 200 through, for example, GUI module 250. The request may be based on an actual request (for example, a first supply chain member requests a loan from a second supply chain member; the second supply chain member may wish to engage with embodiments of the invention to make a decision), or a simulated request (for example, a supply chain member may wish to simulate “what-if” scenarios based on requests it may make of another member, or requests it may receive from another member).

At step 406, modelling module 210 may regenerate model 300 according to one or more of first, second, third, and fourth decision scenarios, corresponding to (i) approving the request, (ii) declining the request, (iii) declining the request but approving another request to finance a loan from another borrower node, and (iv) declining the request, where a competing lender node approves the request. Each regenerated version of model 300 provides a tool to a user of analytics system 1000 to play “what-if” scenarios with model 300, determine the possible impacts on model 300, and make an informed choice.

At step 408, recommending module 220 determines corresponding gain values (R) and probabilities of occurrence (P) for each decision scenario. A gain value may be positive, neutral, or negative; a negative gain value may also be described as a loss value. A probability value for each scenario measures the likelihood that the scenario will occur. Data used to determine these values may be known historical data (for example, data about past financing decisions, current liquidity, financial and accounting records, expert knowledge provided as input into the system through GUI module 250) and/or projected data. This data may be stored on database 260 (FIGS. 2 and 5). This data may be obtained by processing known data through modelling algorithms, such as market modelling algorithms, to determine corresponding values and probabilities of occurrence.

In an embodiment, when considering one of the four decision scenarios, recommending module 220 may determine that there are multiple possible consequences based on the underlying data (for example, the data described in FIG. 5). Each scenario may have, therefore, sub-scenarios, and each sub-scenario may have a probability of occurrence. (R) may represent, then, the expected value of a random variable (a gain value), where the process of finding the random valuable is assumed to be repeated infinite times. (R) may represent, then, the center of the distribution of the random variable over the infinite repetitions. Accordingly, (R) may be calculated as follows, where Rᵢ is the expected return in sub-scenario i, Pᵢ is the probability for the expected return in sub-scenario i, and i is the count of sub-scenarios.

$$( R ) = {\sum }_{i = 1}^{n} {R}_{i} {P}_{i}$$

According to an embodiment, (R) may be determined, in each scenario or sub-scenario, based on the following values (these values may also be referred to as modelling parameters), each of which may be derived using historical data as described in connection with FIG. 5, projected data, a combination thereof, and using modelling algorithms known in the art. They may include, for example, the following: a chance of default value (d); a change in sales value (s); a change in market share value (m); a change in liquidity value (l); a change in strength of supplier relationships value (sr); a change in alliance strength value (as); a probability value (cla) that the competing lender (node 310) approves the loan request; a loss value (clal) based on loss to the lender if the competing lender approves the loan; and an impact value (impv) that measures the impact of the decision on the structure of the supply chain.

Each of these values may be represented as a whole number value, a floating point value between 0-1, a percentage, or another value. Each of these values may be weighted such that it impacts the final value of (R) at a higher or lower degree.

According to an embodiment, the above recited parameters may be determined as follows.

Chance of default value (d): (d) may be calculated based on known, estimated, and projected borrowing information about the borrower (node 308A), including the number of loans the borrower has obtained in the past and the number of such loans that the borrower has defaulted on in the past, or the risk that the borrower has assumed. It may further be based on current assets, credit rating, market trends, and other information. (d) may also be based on similar information of comparable nodes. For example, where the borrower (node 308A) is a retailer, the data for another retailer in the same business sector having comparable revenue can be used. SC analytics program 200 may retrieve this information from database 260 (FIGS. 2A and 5). In one example, the borrower (node 308A) may have had 5 loans in the past 10 years, and defaulted on one of them. In this example, (d)=⅕=0.20, or 20%. Other calculations of (d) are possible, and may include weighting criteria (such as time weighting).

Change in sales value (s): (s) may be calculated based on known, estimated, and projected sales information about the lender (node 304) (or any other node). It may further be based on current assets, inventory, market trends, demand, and other information. (s) may also be based on similar information of comparable nodes. For example, where the lender (node 304) is a retailer, the data for another retailer in the same business sector having comparable revenue can be used. SC analytics program 200 may retrieve this information from database 260 (FIGS. 2A and 5). In one example, SC analytics program 200 may determine that the lender (node 304) has $5 million available cash, which it may provide as a loan to the borrower (node 308A) or invest in advertising. SC analytics program 200 may determine, based on historical data, that if spent on advertising, the $5 million investment will generate an increase of 15% in sales. Providing the $5 million as a loan to the borrower (node 308A) will not allow the lender (node 304) to attain this increase, although sales may increase or decrease for other reasons. Other calculations of (s) are possible, and may include weighting criteria (such as time weighting).

Change in market share value (m): (m) may be calculated based on known, estimated, and projected market share information about the lender (node 304) (or any other node). It may further be based on current assets, inventory, market trends, demand, and other information. (m) may also be based on similar information of comparable nodes. For example, where the lender (node 304) is a retailer, the data for another retailer in the same business sector having comparable revenue can be used. SC analytics program 200 may retrieve this information from database 260 (FIGS. 2A and 5). In one example, SC analytics program 200 may determine that the lender (node 304) has a 10% market share. By providing the loan, the lender (node 304) may obtain additional goods that it can then sell, which may not be available to it without the lending relationship with the borrower (node 308A). Having the extra good available may allow the lender (node 304) to reach additional customers, and therefore increase its market share. In another scenario, the lender (node 304) may lose market share. In one example, (m) may be calculated as: (m)=current_market_share+expected_change. Other calculations of (m) are possible, and may include weighting criteria (such as time weighting).

Change in liquidity value (l): (l) may be calculated based on known, estimated, and projected liquidity information about the lender (node 304) (or any other node). Liquidity may be a measure of the lender's current assets and/or receivables against its current or forthcoming obligations. It may further be based on current assets, inventory, market trends, demand, and other information. (l) may also be based on similar information of comparable nodes. For example, where the lender (node 304) is a retailer, the data for another retailer in the same business sector having comparable revenue can be used. SC analytics program 200 may retrieve this information from database 260 (FIGS. 2A and 5). In one example, SC analytics program 200 may determine that the lender (node 304) has a debt obligation of $2 million in principal, and accruing an annual interest of 8%. By providing the loan to the borrower (node 308A), the lender (node 304) may be unable to pay back the principal amount, and may need to pay the interest instead. In one example, (l) may be calculated as: (l)=current_assets+current_debt. Other calculations of (l) are possible, and may include weighting criteria.

Change in strength of supplier relationships value (sr): (sr) may be calculated based on known, estimated, and projected supplier relationship strengths relative to the lender (node 304) (or relative to any other node). It may further be based on current assets, inventory, market trends, demand, and other information. Supplier relationships strength may be a measure of supplier relationships according to predefined measuring criteria. In one example, each contract between two nodes of model 300 may be assigned a positive point value. If a given contract prevents one node from conducting business with another node, this may lower competition, and may be assigned a negative point value. Based on the predefined measuring criteria, these point values may be aggregated for one or more suppliers of the lender (node 304). (sr) may also be based on similar information of comparable nodes. For example, where the lender (node 304) is a retailer, the data for another retailer in the same business sector having comparable revenue can be used. SC analytics program 200 may retrieve this information from database 260 (FIGS. 2A and 5). In one example, (sr) may be calculated as: (sr)=supplier_contracts_points+loss_of_contracts_with_competitors. Other calculations of (sr) are possible, and may include weighting criteria (for example, a given contract may have strategic importance that makes it more valuable than other contracts irrespective of the sums involved in the contract).

Change in alliance strength value (as): (as) may be calculated based on known, estimated, and projected alliance relationship strengths relative to the lender (node 304) (or relative to any other node). It may further be based on current assets, inventory, market trends, demand, and other information. Alliance strength value may be a measure of alliance node relationships with the lender (node 304). In one example, gain values based on the change in sales, liquidity, supplier relationships, and other factors relative to an alliance member (node 308B) may be measured and calculated for the alliance member, as described above, and elsewhere, with respect to the lender (node 304). The higher the gain value for an alliance member, the higher the (as) value may be. (as) may also be based on similar information of comparable nodes. For example, where the alliance member (node 308B) is a retailer, the data for another retailer in the same business sector having comparable revenue can be used. SC analytics program 200 may retrieve this information from database 260 (FIGS. 2A and 5). In one example, (as) may be calculated as: (as)=Σ₁ⁿ(Rₙ), where Rn represents the (R) value of the n^{th} alliance node. Other calculations of (as) are possible, and may include weighting criteria (for example, a given alliance member may be defined as more important that other alliance members).

Probability value (cla) that the competing lender (node 310) approves the loan request: (cla) may be calculated based on known, estimated, and projected lending decisions of the competing lender (node 310) for a loan request by the borrower (node 308A). It may further be based on current assets, inventory, market trends, demand, and other information of the competing lender (node 310). In one example, (cla) may be based on the number of currently outstanding (or historical information about past) loans provided by the competing lender to one or more borrowers, and/or borrowers that are similarly situated with respect to the borrower (node 308A). For example, SC analytics program 200 may retrieve lending information of the competing lender (node 310) from the database 260. SC analytics program 200 may then determine that the competing lender (node 310) has received fifteen loan requests from eight borrowers similarly situated relative to the borrower (node 308A) in the last six months, and has approved only half of those requests. SC analytics program 200 may determine therefore, that (cla)=50%. Other calculations of (cla) are possible (for example, as the number of approved loans increases, the probability that a subsequent loan request is approved becomes lower), and may include weighting criteria (for example, certain properties such as creditworthiness may be affect the probability; a higher creditworthiness, for example, may make it more probable that a borrower's loan request is approved).

Loss value (clal) based on loss to the lender if the competing lender approves the loan: (clal) may be calculated based on known, estimated, and projected loss (or gain) to the lender (node 304) where the competing lender (node 310) approves a loan request by the borrower (node 308A). It may further be based on current assets, inventory, market trends, demand, and other information of the competing lender (node 310). In one example, (clal) may be based on to change in market share, sales, and other factors relative to the lender (node 304). For example, SC analytics program 200 may retrieve from the database 260 market share and sales information for the lender (node 304) and the competing lender (node 310), and determine that in the event the lender refuses to finance the loan request, and the competing lender accepts to do so instead, the lender's sales and market share will recede (although it may remain unchanged or even grow in some circumstances) lending information of the competing lender (node 310) from the database 260. In one example, SC analytics program 200 may determine (clal) as follows: (clal)=(m)+(s). Other calculations of (clal) are possible, and may include weighting criteria.

Impact value (impv) that measures the impact of the decision on the structure of the supply chain: (impv) may be calculated based on known, estimated, and projected impact of a decision on the structure of model 300. It may further be based on current or past relationships between nodes of model 300 and their individual properties. Some or all node properties and connections may be assigned an impv value based on impact measurement criteria. In one example, the criteria may include definitions of individual impv values of edges in model 300 such that the more edges there, the higher the (impv) value. In another example, the criteria may include definitions such that edges corresponding to relationships between a competitor and other members of the supply chain have a negative value and lower the (impv) value. Accordingly, in one example, SC analytics program 200 may determine (impv) as the sum of individual impv values defined for nodes in model 300, properties of the nodes, their edges, and other factors. Other calculations of (impv) are possible, and may include weighting criteria (for example, relationships between the lender (node 304) and alliance members (node 308B) may have a higher weight than other relationships). Accordingly, embodiments of the invention may determine an impact of a decision scenario or sub-scenario on the structure of model 300, and may assess its properties, including, for example, its desirability.

In calculating the above values, modelling algorithms may receive known historical data about the supply chain members, or entities (for example, companies) similar to the supply chain members, to determine corresponding attributes, such as market capital, cash on hand, risk averment, projected growth plan, etc. Similar information may be used to estimate future values.

In an embodiment, the probabilities of occurrence of each scenario or sub-scenario may be based on a probabilistic assumption. For example, the probability of each possible scenario or sub-scenario may be calculated by assuming that the probability of occurrence of the given scenario or sub-scenario is a Gaussian distribution, a Pareto distribution, or a Poisson distribution. In a related embodiment, the assumptions may be based on constant expected return probabilistic models. These models are known to a person of ordinary skill in the art. Exemplary and non-limiting constant expected return models are described in the following source, incorporated by reference in its entirety: Eric Zivot, University of Washington: The Constant Expected Return Model [online; retrieved on 2014-12-10]. Retrieved from the Internet: <URL: http://faculty.washington.edu/ezivot/econ424/constantexpectedreturn.pdf Chapter 1. Additional examples are described in the following source, incorporated by reference in its entirety: Lewellen, J. The Time-Series Relations Among Expected Return, Risk, and Book-to-market, Journal of Financial Economics, Vol. 54, no. 5-43 (1999).

Additional details of method 400 at steps 406 and 408 are described below for each of the four decision scenarios, in turn, in connection with an illustrative example. In the illustrative example, it is assumed that: the borrower making a request for financing is SC Member 2 (node 308A); the request is directed to the lender (node 304; FIG. 3); SC Member 7 (node 308C) is a competing borrower; and competing lender (node 310) is an alternative financing source for SC Member 2.

Modelling module 210 may regenerate model 300, at step 406, according to the first decision scenario, i.e., approving the request, as follows. Modelling module 210 may assume that the request is approved, and recalculate properties of model 300, its nodes, and the connections between the nodes, using the node metadata and additional data in database 260 (FIG. 5), which may include, for example, historical data.

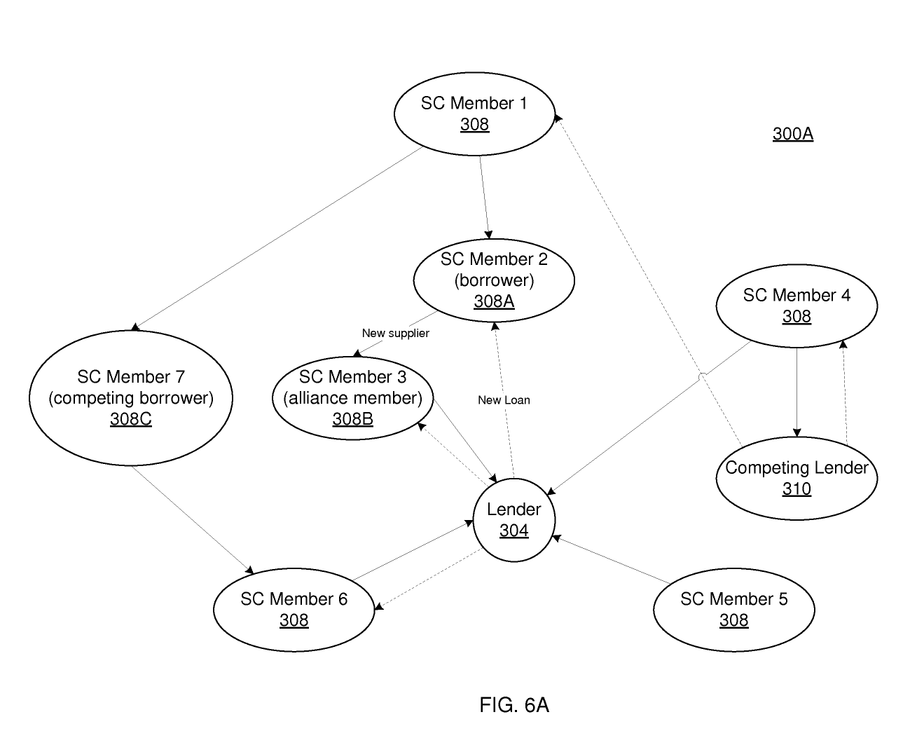

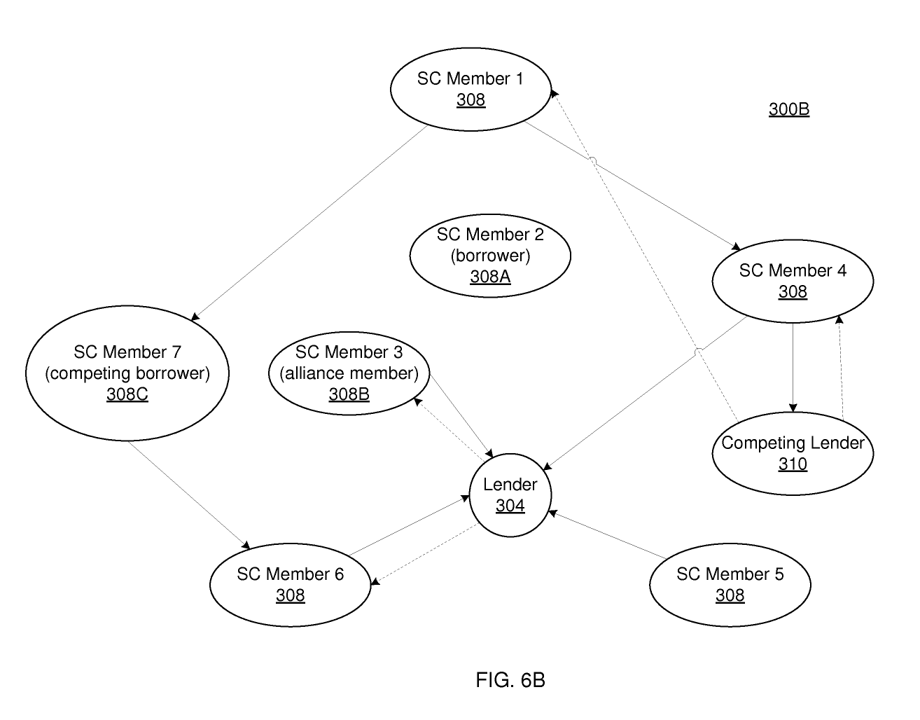

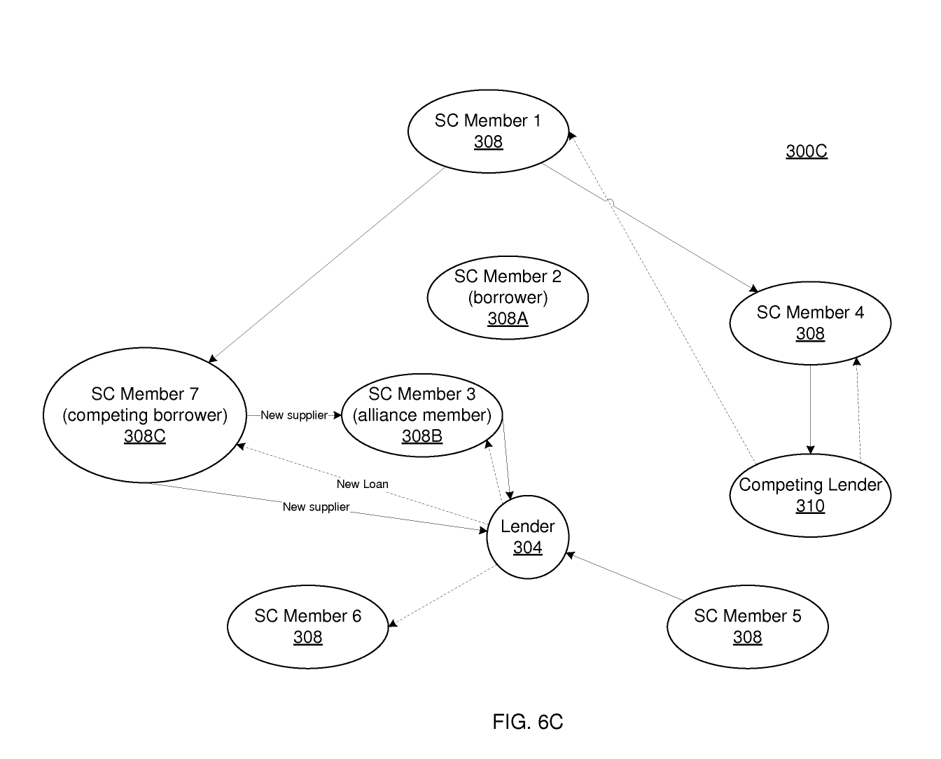

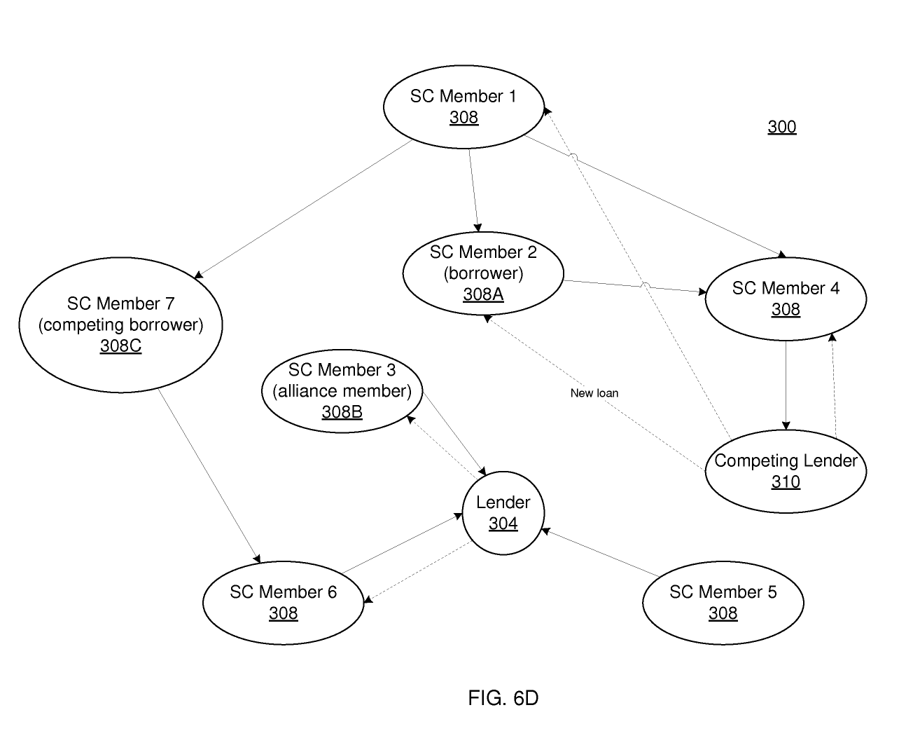

FIG. 6A shows an exemplary graph of a regenerated model 300A, simulating a possible effect of the first decision scenario on model 300. The graph of model 300A may be generated by graphing module 230. As depicted, the lender (node 304) is assumed to approve the loan request from SC Member 2. This relationship is indicated in the graph as a new dashed line from the lender (node 304) to SC Member 2 (node 308A). SC Member 2 becomes a supplier to SC Member 3 (node 308B), which is an alliance member of the supply chain of model 300, relative to the lender (node 304). Based on predefined properties of SC Member 2 (node 308A), modelling module 210 may determine, based on known supply capacity of SC Member 2, and known demand of SC Members 3 and 4 (as stored, for example, in database 206), that SC Member 2 cannot simultaneously supply the demand of both SC Member 3 and SC Member 4. Therefore, regenerated model 300A assumes that the decision to approve the request results in a change in the supply chain.

Based on properties of regenerated model 300A, recommending module 220 may determine, at step 408, a corresponding expected return value (R) that is measured relative to the lender (node 304), for providing a loan to the borrower, SC member 2 (node 308A). The estimate may be, in one example, based on the following subset of factors listed above: the chance of default value (d); the change in sales value (s); the change in market share value (m); the change in liquidity value (l); the change in strength of supplier relationships value (sr); the change in alliance strength value (as); and an impact value (impv) that measures the impact of the decision on the structure of the supply chain. For any given sub-scenario, these values may be determined and summed, averaged, or combined in another way to arrive at a corresponding value for (R).

For any given sub-scenario, these values may be determined and summed, averaged, or combined in another way to arrive at a corresponding final value for (R).

Recommending module 220 may also determine the probability (P) of occurrence for (R) for each sub-scenario of the first scenario. Recommending module may multiply these values for each sub-scenario, and aggregate them, to determine a single (R) value for the first scenario.

Modelling module 210 may regenerate model 300, at step 406, according to the second decision scenario, i.e., declining the request, as follows. Modelling module 210 may assume that the request is declined, and recalculate properties of model 300, its nodes, and the connections between the nodes, using the node metadata and additional data in database 260 (FIG. 5), which may include, for example, historical data.

FIG. 6B shows an exemplary graph of a regenerated model 300B, simulating the effect of the second decision scenario on model 300. The graph may be generated by graphing module 230. As depicted, the lender (node 304) is assumed to decline the loan request from SC Member 2. A further assumption in this decision scenario is that no other lenders are available to SC Member 2. This relationship is indicated in the graph as SC Member 2 (node 308A) losing its financing and existing the supply chain altogether, since without financing, it may be unable to obtain goods from SC Member 1 (node 308) (these assumptions may be based on known information contained in database 260, as shown in FIG. 5). Therefore, regenerated model 300B assumes that the decision to decline the request results in a change in the supply chain.

Based on properties of regenerated model 300B, recommending module 220 may determine (R), at step 408, based on declining to provide a loan to the borrower, SC member 2 (node 308A). The determination may be, in one example, based on the following subset of factors: the change in sales value (s); the change in market share value (m); the change in liquidity value (l); the change in strength of supplier relationships value (sr); the change in alliance strength value (as); and the impact value (impv) that measures the impact of the decision on the structure of the supply chain. For any given sub-scenario, these values may be determined and summed, averaged, or combined in another way to arrive at a corresponding value for (R).

For any given sub-scenario, these values may be determined and summed, averaged, or combined in another way to arrive at a corresponding final value for (R).

Recommending module 220 may also determine the probability (P) of occurrence for (R) for each sub-scenario of scenario two. Recommending module may multiply these values for each sub-scenario, and aggregate them, to determine a single (R) value for the second scenario.

Modelling module 210 may regenerate model 300, at step 406, according to the third decision scenario, i.e., declining the request but approving another request to finance a loan from another borrower node, as follows. Modelling module 210 may assume that the request is declined, and that a request from the competing borrower, SC Member 7 (node 308C) is accepted, and recalculate properties of model 300, its nodes, and the connections between the nodes, using the node metadata and additional data in database 260 (FIG. 5), which may include, for example, historical data.

FIG. 6C shows an exemplary graph of a regenerated model 300C, simulating the effect of the third decision scenario on model 300. The graph may be generated by graphing module 230. As depicted, the lender (node 304) is assumed to decline the loan request from SC Member 2. SC member 2 is left without a financing source (assuming that no other lenders are available). Additionally, SC Member 7 is indicated as a new supplier to SC Member 3, the lender's (node 304) alliance member, and a new supplier to the lender (node 304). The lender's (node 304) lending relationship is illustrated using a dashed line to SC Member 7.

Based on properties of regenerated model 300C, modelling module 210 may determine that since SC Member 7 is a new supplier to the lender (node 304), the lender no longer requires SC Members 4 and 6 to be its suppliers. Therefore, regenerated model 300C assumes that the decision to decline the request from SC Member 2, and instead accepting a competing request from SC Member 7, results in a change in the supply chain.

Based on properties of regenerated model 300C, recommending module 220 may determine, at step 408, a corresponding expected return value (R) that is measured relative to the lender (node 304), for declining to provide a loan to the borrower, SC member 2 (node 308A), and instead providing a loan to the competing borrower, SC Member 7. The estimate may be, in one example, based on the following subset of factors listed above: the chance of default value (d) with respect to SC Member 7; the change in sales value (s); the change in market share value (m); the change in liquidity value (l); the change in strength of supplier relationships value (sr); the change in alliance strength value (as); and an impact value (impv) that measures the impact of the decision on the structure of the supply chain. For any given sub-scenario, these values may be determined and summed, averaged, or combined in another way to arrive at a corresponding value for (R).

For any given sub-scenario, these values may be determined and summed, averaged, or combined in another way to arrive at a corresponding final value for (R).

Recommending module 220 may also determine the probability (P) of occurrence for (R) for each sub-scenario of scenario three. Recommending module may multiply these values for each sub-scenario, and aggregate them, to determine a single (R) value for the third scenario.

Modelling module 210 may regenerate model 300, at step 406, according to the fourth decision scenario, i.e., declining the request, where a competing lender node approves the request, as follows. Modelling module 210 may assume that the request from SC Member 2 is declined, but that the competing lender (node 310) approves the request, and recalculate properties of model 300, its nodes, and the connections between the nodes, using the node metadata and additional data in database 260 (FIG. 5), which may include, for example, historical data.

FIG. 6D shows an exemplary graph of a regenerated model 300D, based on changes made to model 300. The graph may be generated by graphing module 230. As depicted, the lender (node 304) is assumed to decline the loan request from SC Member 2. A further assumption in this decision scenario is that the competing lender (node 310) approves the financing decision. This relationship is indicated in the graph as a new dashed line between competing lender and SC Member 2 (node 308A). Additionally, since the financing is provided by the competing lender (node 310) to SC Member 2, based on properties of each and of the supply chain as a whole, modelling module 210 assumes that SC Member 2 provides greater supplies to SC Member 4 (node 308), and that SC Member 4 provides greater supplies to the competing lender (node 310); therefore, SC Member 4 and can no longer supply the lender (node 304). Therefore, regenerated model 300D assumes that the decision to decline the request, where the request is approved by another lender, results in a change in the supply chain.

Based on properties of regenerated model 300D, recommending module 220 may determine, at step 408, a corresponding expected return value (R) that is measured relative to the lender (node 304). The estimate may be, in one example, based on the following subset of factors listed above: the change in sales value (s); the change in market share value (m); the change in liquidity value (l); the change in strength of supplier relationships value (sr); the change in alliance strength value (as); the probability value (cla) that the competing lender (node 310) approves the loan request; the loss value (clal) based on loss to the lender if the competing lender approves the loan; and the impact value (impv) that measures the impact of the decision on the structure of the supply chain. For any given sub-scenario, these values may be determined and summed, averaged, or combined in another way to arrive at a corresponding value for (R).

For any given sub-scenario, these values may be determined and summed, averaged, or combined in another way to arrive at a corresponding final value for (R).

Recommending module 220 may also determine the probability (P) of occurrence for (R) for each sub-scenario of the fourth scenario. Recommending module may multiply these values for each sub-scenario, and aggregate them, to determine a single (R) value for the fourth scenario.

At step 410, recommending module 216 evaluates the various (R) and (P) values for each scenario (and sub-scenario), individually or aggregately, and ranks them in order, and assigned an associated confidence level to the values. For example, the aggregate (R) value (considering the impact of probabilities) may be (0.25) for the first scenario, (0.80) for the second scenario, (0.50) for the third scenario, and (0.05) for the fourth scenario. Recommending module 216 may rank the decision scenarios as follows: second scenario, first scenario, third scenario, and fourth scenario. Each ranked value may also be paired with a confidence level (which may be a percentage). This information may be presented to a user. The user (which may represent the lender (node 304)) may determine from the analysis of recommendation module 216, that the second scenario has the highest return value, and that accordingly, the best course of action would be to deny the borrower's request for a loan.

In a related embodiment, at an additional step (not shown) of method 400, recommending module 220 may estimate a long-term impact value on the lender (node 304) based on a decision to finance, or to decline to finance, the loan. This long-term estimate may be based on the factors described above for calculating (R) and (P), and may further include a time dimension T. T may be in the range of {Tn, Tₙ₊₁, Tₙ₊₂, . . . }. The constant expected return models described above may be iterated for two or more values of T to determine the impact on the supply chain over time.

FIG. 5 is a block diagram illustrating information sources that may be used to determine expected return values, expected loss values, impact values, and long-term impact values, according to an embodiment of the invention. FIG. 5 includes components of analytics system 1000 of FIG. 2, such as database(s) 260 and SC analytics program 200. Data used to generate the above referenced values may be stored on database 260, and retrieved by SC analytics program 200 for use by its modules, as described above in connection with FIGS. 3 and 4.

For example, data that may be used to determine the expected return value (R) and other values may include, without limitation, borrower node information, lender node information, competing supplier node information, market information, alliance information, and supplier chain information.

Referring now to FIGS. 3 and 6A-D, according to an aspect of the invention, modelling module 210 may generate model 300 (and regenerate model 300 based on changed to the underlying supply chain data) as described above. Graphing module 230 may generate corresponding graphs, where display properties of a given node (for example, a node's size, color, shape, position, or other property) and its connections/edges with other nodes (for example, thickness, color, weight, dashed/continuity, and other properties), for any given scenario or sub-scenario, correspond to the relative desirability of the scenario or sub-scenario relative to that node, or relative to a reference node. For example, for any given scenario or sub-scenario, relative desirability may refer to the value of (R), and may be represented using a color scale, where green is most desirable, white is neutral, and red is undesirable, corresponding to positive, neutral, and negative values of (R), respectively. Similarly, a thickness of a connection line (or another property of a connection or edge) may represent the amount of capital flow or goods flow represented by that connection. A color indicator may signify whether the flow is increased/reduced compared to a default scenario. Similarly, a size of a node relative to other nodes may indicate the (R) value for that node, and other nodes may have corresponding (R) values in each scenario or sub-scenario.

In an embodiment, properties or characteristics of a connection or edge between two given nodes may represent a flow of goods and/or capital between them. A measure of this flow may be referred to as a flow value.

Referring now to FIG. 7, a computing device 1000 (e.g., analytics system 1000 in FIG. 2) may include respective sets of internal components 800 and external components 900. Each of the sets of internal components 800 includes one or more processors 820; one or more computer-readable RAMs 822; one or more computer-readable ROMs 824 on one or more buses 826; one or more operating systems 828; one or more software applications (e.g., device driver modules) executing method 400 (FIG. 4); and one or more computer-readable tangible storage devices 830. The one or more operating systems 828 and device driver modules are stored on one or more of the respective computer-readable tangible storage devices 830 for execution by one or more of the respective processors 820 via one or more of the respective RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a thin provisioning storage device, CD-ROM, DVD, SSD, memory stick, magnetic tape, magnetic disk, optical disk or semiconductor storage device. The R/W drive or interface 832 may be used to load the device driver 840 firmware, software, or microcode to tangible storage device 936 to facilitate communication with components of computing device 1000.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The operating system 828 that is associated with computing device 1000, can be downloaded to computing device 1000 from an external computer (e.g., server) via a network (for example, the Internet, a local area network or wide area network) and respective network adapters or interfaces 836. From the network adapters (or switch port adapters) or interfaces 836 and operating system 828 associated with computing device 1000 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for generating an electronic data model, comprising:
obtaining an electronic data model of a logical supply chain, the electronic data model comprising a lender node and a borrower node;
regenerating the electronic data model based on at least one decision scenario in response to a request by the borrower node to the lender node to finance a loan, wherein the request is based on one or more of a request received from the borrower node and a simulated request from the borrower node;
determining corresponding gain values and probabilities of occurrence, for the lender node, of the at least one decision scenario, wherein the corresponding gain values and probabilities of occurrence are determined with respect to the lender node and at least one node in the electronic data model other than the borrower node; and
recommending a decision according to the at least one decision scenario, in response to the request, based on the gain values and probabilities of occurrence.

2. The method of claim 1, wherein determining corresponding gain values and probabilities of occurrence comprises determining one or more of:
a chance of default value;
a change in sales value;
a change in market share value;
a change in liquidity value;
a change in strength of supplier relationships value;
a change in alliance strength value;
a probability of occurrence value of one or more decision scenarios, corresponding to a decision by a competing lender node, as to the request;
a loss value based on loss to the lender node if the competing lender node approves the request; and
an impact value that measures the impact of a response to the request on a structure of the electronic data model.

3. The method of claim 1, wherein determining corresponding gain values and probabilities of occurrence further comprises determining a long-term-impact value for the at least one decision scenario.

4. The method of claim 1, further comprising:
generating a graph of the electronic data model, wherein a size of a graphical representation of a given node in the electronic data model is based on a corresponding gain value of the given node; and wherein a thickness of an edge of the graph between two given nodes indicates a flow value between the two given nodes.

5. The method of claim 1, further comprising:
communicating results of the recommending to a user;
receiving electronic input data in response to communicating the results, the electronic input data corresponding to one or more of (i) a new node definition, (ii) a new lender node definition, and (iii) a new relationship definition between two nodes;
regenerating the electronic data model based on the electronic input data; and
repeating one or more steps of the method to provide a new recommendation.

6. The method of claim 1, wherein determining corresponding probabilities of occurrence comprises:
retrieving historical data associated with properties of nodes of the electronic data model;
generating one or more electronic data models using the historical data; and
determining a probability of occurrence for at least one of the one or more electronic data models.

7. The method of claim 1, further comprising:
determining additional gain values and probabilities of occurrence, for one or more additional nodes, wherein the recommending is further based on the additional gain values and probabilities of occurrence.

8. A computer system for generating an electronic data model, comprising:
a computer device having a processor and a tangible storage device; and
a program embodied on the storage device for execution by the processor, the program having a plurality of program instructions to:
obtain an electronic data model of a logical supply chain, the electronic data model comprising a lender node and a borrower node;
regenerate the electronic data model based on at least one decision scenario in response to a request by the borrower node to the lender node to finance a loan, wherein the request is based on one or more of a request received from the borrower node and a simulated request from the borrower node;
determine corresponding gain values and probabilities of occurrence, for the lender node, of the at least one decision scenario, wherein the corresponding gain values and probabilities of occurrence are determined with respect to the lender node and at least one node in the electronic data model other than the borrower node; and
recommend a decision according to the at least one decision scenario, in response to the request, based on the gain values and probabilities of occurrence.

9. The system of claim 8, wherein instructions to determine corresponding gain values and probabilities of occurrence further comprise instructions to determine one or more of:
a chance of default value;
a change in sales value;
a change in market share value;
a change in liquidity value;
a change in strength of supplier relationships value;
a change in alliance strength value;
a probability of occurrence value of one or more decision scenarios, corresponding to a decision by a competing lender node, as to the request;
a loss value based on loss to the lender node if the competing lender node approves the request; and
an impact value that measures the impact of a response to the request on a structure of the electronic data model.

10. The system of claim 8, wherein instructions to determine corresponding gain values and probabilities of occurrence further comprise instructions to determine a long-term-impact value for the at least one decision scenario.

11. The system of claim 8, wherein the program instructions further comprise instructions to:
generate a graph of the electronic data model, wherein a size of a graphical representation of a given node in the electronic data model is based on a corresponding gain value of the given node; and wherein a thickness of an edge of the graph between two given nodes indicates a flow value between the two given nodes.

12. The system of claim 8, wherein the program instructions further comprise instructions to:
communicate results of the recommending to a user;
receive electronic input data in response to communicating the results, the electronic input data corresponding to one or more of (i) a new node definition, (ii) a new lender node definition, and (iii) a new relationship definition between two nodes;
regenerate the electronic data model based on the electronic input data; and
repeat one or more steps of the method to provide a new recommendation.

13. The system of claim 8, wherein instructions to determine corresponding probabilities of occurrence further comprise instructions to:
retrieve historical data associated with properties of nodes of the electronic data model;
generate one or more electronic data models using the historical data; and
determine a probability of occurrence for at least one of the one or more electronic data models.

14. A computer program product for generating an electronic data model, comprising a tangible storage device having program code embodied therewith, the program code executable by a processor of a computer to perform a method, the method comprising:
obtaining, by the processor, an electronic data model of a logical supply chain, the electronic data model comprising a lender node and a borrower node;
regenerating the electronic data model based on at least one decision scenario in response to a request by the borrower node to the lender node to finance a loan, wherein the request is based on one or more of a request received from the borrower node and a simulated request from the borrower node;
determining, by the processor, corresponding gain values and probabilities of occurrence, for the lender node, of the at least one decision scenario, wherein the corresponding gain values and probabilities of occurrence are determined with respect to the lender node and at least one node in the electronic data model other than the borrower node; and
recommending, by the processor, a decision according to the at least one decision scenario, in response to the request, based on the gain values and probabilities of occurrence.

15. The computer program product of claim 14, wherein determining corresponding gain values and probabilities of occurrence further comprises determining, by the processor, one or more of:
a chance of default value;
a change in sales value;
a change in market share value;
a change in liquidity value;
a change in strength of supplier relationships value;
a change in alliance strength value;
a probability of occurrence value of one or more decision scenarios, corresponding to a decision by a competing lender node, as to the request;
a loss value based on loss to the lender node if the competing lender node approves the request; and
an impact value that measures the impact of a response to the request on a structure of the electronic data model.

16. The computer program product of claim 14, wherein determining corresponding gain values and probabilities of occurrence further comprises determining, by the processor, a long-term-impact value for the at least one decision scenario.

17. The computer program product of claim 14, wherein the method further comprises:
generating, by the processor, a graph of the electronic data model, wherein a size of a graphical representation of a given node in the electronic data model is based on a corresponding gain value of the given node; and wherein a thickness of an edge of the graph between two given nodes indicates a flow value between the two given nodes.

18. The computer program product of claim 14, wherein the method further comprises:
communicating, by the processor, results of the recommending to a user;
receiving, by the processor, electronic input data in response to communicating the results, the electronic input data corresponding to one or more of (i) a new node definition, (ii) a new lender node definition, and (iii) a new relationship definition between two nodes;
regenerating, by the processor, the electronic data model based on the electronic input data; and
repeating, by the processor, one or more steps of the method to provide a new recommendation.

19. The computer program product of claim 14, wherein determining corresponding probabilities of occurrence further comprises:
retrieving, by the processor, historical data associated with properties of nodes of the electronic data model;
generating, by the processor, one or more electronic data models using the historical data; and
determining, by the processor, a probability of occurrence for at least one of the one or more electronic data models.

20. The computer program product of claim 14, further comprising:
determining, by the processor, additional gain values and probabilities of occurrence, for one or more additional nodes, wherein the recommending is further based on the additional gain values and probabilities of occurrence.
